(19) United States
(12) Patent Application Publication
(10) Pub. No.: US 2026/0323726 A1
(43) Pub. Date: Oct. 15, 2026

(54) DATA TRANSMISSION METHOD AND RELATED APPARATUS

(71) Applicant: Lenovo (Beijing) Limited, Beijing (CN)

(72) Inventor: Bin FU, Beijing (CN)

(21) Appl. No.: 19/690,928

(22) Filed: May 28, 2026

Related U.S. Application Data
(63) Continuation of application No. PCT/CN2024/117102, filed on Sep. 5, 2024.

(30) Foreign Application Priority Data
Nov. 29, 2023 (CN) 202311618980.7

(51) Int. Cl. H04W 74/0833

(52) U.S. Cl. CPC H04W 74/085; H04W 74/0858

(57) ABSTRACT

A data transmission method includes obtaining a current data frame, determining a data transmission strategy based on a size of the current data frame and a current threshold, and transmitting the current data frame based on the data transmission strategy. The current threshold is determined based on retransmission information of a previous data frame before the current data frame, the data transmission strategy is configured to characterize a collision detection strategy adopted during transmission of the current data frame, the collision detection strategy includes a first strategy and a second strategy, and a number of handshake interactions between a receiver and a transmitter under the first strategy is greater than a number of handshake interactions between the receiver and the transmitter under the second strategy.

### CROSS-REFERENCE TO RELATED APPLICATIONS

This application is a continuation of International Application No. PCT/CN 2024/117102, filed on Sep. 5, 2024, which claims priority to Chinese Patent Application No. 202311618980.7, filed on Nov. 29, 2023, the entire contents of both of which are incorporated herein by reference.

### TECHNICAL FIELD

The present disclosure relates to the field of wireless communications, and in particular, to a data transmission method and a related apparatus.

### BACKGROUND

Since a wireless channel has a characteristic of a collision domain, in order to avoid a collision problem caused when multiple nodes simultaneously access a network, the related art uses a Carrier Sense Multiple Access with Collision Avoidance (CSMA/CA) mechanism to implement collision avoidance. However, because a Contention Window (CW) size is limited, there is still a certain probability that two terminals randomly select a same contention window, thereby causing a collision when the two terminals access a medium.

### SUMMARY

In accordance with the present disclosure, there is provided a data transmission method including obtaining a current data frame, determining a data transmission strategy based on a size of the current data frame and a current threshold, and transmitting the current data frame based on the data transmission strategy. The current threshold is determined based on retransmission information of a previous data frame before the current data frame, the data transmission strategy is configured to characterize a collision detection strategy adopted during transmission of the current data frame, the collision detection strategy includes a first strategy and a second strategy, and a number of handshake interactions between a transmitter and a receiver under the first strategy is greater than a number of handshake interactions between the transmitter and the receiver under the second strategy.

Also in accordance with the present disclosure, there is provided a data transmission device including a processor and a memory storing instructions that, when executed by the processor, cause the data transmission device to obtain a current data frame, determine a data transmission strategy based on a size of the current data frame and a current threshold, and transmit the current data frame based on the data transmission strategy. The current threshold is determined based on retransmission information of a previous data frame before the current data frame, the data transmission strategy is configured to characterize a collision detection strategy adopted during transmission of the current data frame, the collision detection strategy includes a first strategy and a second strategy, and a number of handshake interactions between a transmitter and a receiver under the first strategy is greater than a number of handshake interactions between the transmitter and the receiver under the second strategy.

Also in accordance with the present disclosure, there is provided a non-transitory computer-readable storage medium storing a program that, when executed by a processor, causes a data transmission device including the processor to obtain a current data frame, determine a data transmission strategy based on a size of the current data frame and a current threshold, and transmit the current data frame based on the data transmission strategy. The current threshold is determined based on retransmission information of a previous data frame before the current data frame, the data transmission strategy is configured to characterize a collision detection strategy adopted during transmission of the current data frame, the collision detection strategy includes a first strategy and a second strategy, and a number of handshake interactions between a transmitter and a receiver under the first strategy is greater than a number of handshake interactions between the transmitter and the receiver under the second strategy.

### BRIEF DESCRIPTION OF THE DRAWINGS

The accompanying drawings herein are incorporated into the specification and constitute a part of the specification, and the accompanying drawings illustrate embodiments consistent with the present disclosure and, together with the specification, are used to explain the technical solutions of the present disclosure.

FIG. 1 schematically illustrates the implementation of a CSMA/CA mechanism in the present disclosure.

FIG. 2 schematically illustrates the implementation of an RTS/CTS protocol in the present disclosure.

FIG. 3 is a schematic flowchart of implementation of a data transmission method in the present disclosure.

FIG. 4 is a schematic flowchart of implementation of a data transmission method in the present disclosure.

FIG. 5 is a schematic diagram of an application scenario of a data transmission method in the present disclosure.

FIG. 6 is a schematic flowchart of implementation of a data transmission method in the present disclosure.

FIG. 7 is a schematic flowchart of implementation of a data transmission method in the present disclosure.

FIG. 8 is a schematic diagram of a composition structure of a data transmission apparatus in the present disclosure.

FIG. 9 is a schematic diagram of a hardware entity of a data transmission device in the present disclosure.

### DETAILED DESCRIPTION OF THE EMBODIMENTS

In order to make the objectives, technical solutions, and advantages of the present disclosure clearer, the technical solutions of the present disclosure are further described in detail below with reference to the accompanying drawings and embodiments. The described embodiments should not be construed as limiting the present disclosure. All other embodiments obtained by those skilled in the art without making creative effort fall within the scope of the present disclosure.

The following description associated with “some embodiments” and describes a subset of all possible embodiments, it can also be understood that “some embodiments” can be a same subset or different subsets of all possible embodiments, and can be combined with each other without conflict.

The terms associated with “first/second/third” are merely used to distinguish similar objects, and do not represent a specific ordering directed to the objects. It can be understood that “first/second/third” can interchange a specific order or sequence where permitted, such that the embodiments of the present disclosure described herein can be implemented in an order other than the order illustrated or described herein.

Unless otherwise defined, all technical and scientific terms used herein have the same meanings as commonly understood by those skilled in the technical field of the present disclosure. The terms used herein are merely for the purpose of describing the present disclosure, and are not intended to limit the present disclosure.

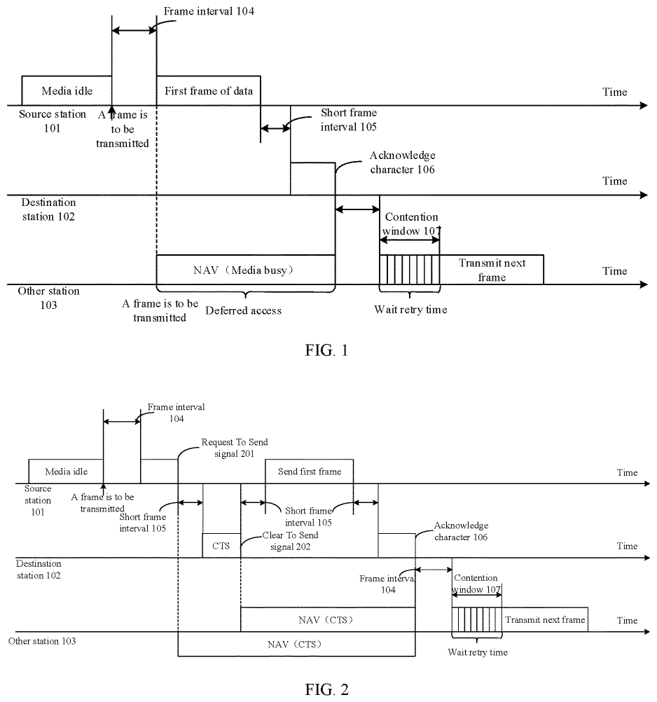

In the related art, in order to avoid a collision problem caused when multiple nodes simultaneously access a network, the related art uses a CSMA/CA mechanism to implement collision avoidance. As shown in FIG. 1, in a case where a source station 101 has a data frame (PSDU, Physical Layer Service Data Unit) to transmit, the source station 101 first needs to monitor whether a destination station is idle within a range of a frame interval 104. If the destination station 102 is idle within a time range of the frame interval 104, the source station 101 transmits a first frame of data to the destination station 102. After the destination station 102 receives the first frame of data transmitted by the source station 101 and a short frame interval 105 elapses, the destination station 102 transmits an acknowledge character 106 (Acknowledge character, ACK) to the source station to indicate that the data is successfully received. At this time, during a period from the source station transmitting the first frame of data to the destination station transmitting the acknowledge character 106, the destination station is in a “media busy” state, and other station 103 cannot transmit data to the destination station 102. The other station 103 needs to monitor whether the destination station 102 is idle. After the destination station 102 transmits the ACK and the other station 103 monitors that the destination station 102 is idle within a time range of a frame interval 104 plus a Contention Window 107 (CW), the other station 103 can transmit data. However, since a contention window size is limited, there is still a certain probability that two other stations randomly select a same contention window, thereby causing a collision when the two other stations access a medium, that is, causing a situation where data is simultaneously transmitted to the destination station from two other stations. In addition, due to characteristics of wireless communication, a sender of data cannot perform collision detection on data transmitted by itself, and can only rely on an ACK of a receiver to confirm whether the data is successfully transmitted. When the data frame is relatively long, a collision detection period also becomes longer correspondingly.

In order to solve the foregoing problem, a threshold (dot11RTSThreshold) is defined in the 802.11 protocol. When a length of a PSDU exceeds the threshold, before actual data transmission starts, a transmitting side and a receiving side first perform a Request To Send/Clear To Send (RTS/CTS) handshake. As shown in FIG. 2, when a data frame transmitted by a source station 101 is greater than the threshold, the source station 101 needs to transmit a Request To Send (Require To Send, RTS) signal 201 to a destination station 102 after a frame interval 104. If, after a short frame interval 105, a Clear To Send (CTS) signal 202 transmitted by the destination station 102 is received, the data frame can be transmitted to the destination station 102 after another short frame interval 105. As shown in FIG. 2, during a period from the source station 101 transmitting the Request To Send signal 201 to the destination station 102 transmitting the ACK, the destination station 102 is in a “media busy” state, and other station 103 cannot transmit data to the destination station during this period.

Since RTS and CTS are control frames and do not carry any data, a collision detection period thereof is very short. Meanwhile, a duration field in the RTS and CTS control frames reserves channel resources for subsequent data transmission, thereby avoiding subsequent collisions. However, the threshold in the 802.11 protocol is statically configured. That is, after the threshold is statically configured, regardless of how a to-be-sent data frame changes, the to-be-sent data frame is compared with a same threshold to determine whether to perform an RTS/CTS handshake. In this way, a data transmission strategy determined each time cannot match the current to-be-sent data frame.

In order to solve technical problems existing in the related art, embodiments of the present disclosure provide a data transmission method, and the method is applied to a data transmission apparatus. The data transmission apparatus can be disposed in electronic devices having processing functions, such as personal computers, mobile terminals, and servers, or can be implemented by a processor executing a computer program. The following description uses an electronic device as an executing entity for illustration.

FIG. 3 is a schematic flowchart of implementation of a data transmission method in the present disclosure. As shown in FIG. 3, the method includes the following operations S301 to S303.

At S301, a current data frame is obtained.

The current data frame is used to characterize a to-be-sent data frame.

In some embodiments, a transmission sequence of multiple data frames can be obtained, and a current to-be-sent data frame can be obtained based on the transmission sequence.

At S302, a data transmission strategy is determined based on a size of the current data frame and a current threshold.

The current threshold is determined based on retransmission information of a previous data frame before the current data frame. That is, the current threshold is a dynamic threshold, and changes with a change in the retransmission information of the previous data frame. In some embodiments, the previous data frame is used to characterize at least one group of data frames having a transmission time before the current data frame and adjacent to the current data frame, and each group of data frames includes at least one frame of data.

The retransmission information of the previous data frame is used to characterize a data collision condition of the previous data frame. In the present disclosure, the retransmission information of the previous data frame can include at least one of the following: a retransmission count of the previous data frame, a retransmission response time of the previous data frame, and a packet loss rate of the previous data frame.

For example, the retransmission count of the previous data frame can be a sum of retransmission counts of part of data in the data frame. For example, retransmission occurs for an 8th data packet, a 9th data packet, and a 200th data packet in the frame, and the retransmission count of the previous data frame is 3; for example, the retransmission count of the previous data frame can include a sum of retransmission counts of data packets in one group (multiple) of data frames. For example, the retransmission count of the previous data frame can be a count of times the previous data frame is transmitted when the previous data frame is successfully transmitted. For example, if the data frame is not successfully transmitted until a 4th transmission, the retransmission count of the data frame is 4. In some embodiments, whether the data frame or a data packet in the data frame is successfully transmitted can be determined according to whether an ACK is received, that is, in a case where an ACK corresponding to the previous data frame is received, a transmission count of the data frame or a transmission count of the data packet is determined. When the retransmission count of the previous data frame is relatively large, the previous data frame has relatively more data collisions and the data collision condition is worse; and when the retransmission count of the previous data frame is relatively small, the previous data frame has less data collisions and the data collision condition is better.

For example, the retransmission response time of the previous data frame can be a time between a first transmission of the previous data frame and successful transmission of the previous data frame. In some embodiments, in a case where an ACK corresponding to the previous data frame is received, a time between the first transmission of the previous data frame and reception of the ACK corresponding to the previous data frame can be determined. For example, the retransmission response time of the previous data frame can be a sum of response times of each data packet or each group of data packets in which retransmission occurs in one or more previous frames. When the retransmission response time of the previous data frame is relatively long, it indicates that the previous data frame has more data collisions and the data collision condition is relatively poor; and when the retransmission response time of the previous data frame is relatively short, it indicates that the previous data frame has less data collisions and the data collision condition is better.

For example, the packet loss rate of the previous data frame can be a ratio of a total quantity of data packets unsuccessfully transmitted in one or more previous frames to a total data packet quantity of the previous data frame. When the packet loss rate of the previous data frame is relatively large, it indicates that the previous data frame has more data collisions and the data collision condition is relatively poor; and when the packet loss rate of the previous data frame is relatively small, it indicates that the previous data frame has less data collisions and the data collision condition is better.

In the present disclosure, the foregoing data transmission strategy is used to characterize a collision detection strategy adopted during transmission of the current data frame. The collision detection strategy includes a first strategy and a second strategy, and a number of handshake interactions between a transmitter and a receiver under the first strategy is greater than a number of handshake interactions between the transmitter and the receiver under the second strategy. Since the number of handshake interactions corresponding to the first strategy is greater than the number of handshake interactions corresponding to the second strategy, accuracy of collision detection of the first strategy is also greater than accuracy of collision detection of the second strategy. For example, the first strategy can refer to a strategy using an RTS/CTS handshake in the CSMA/CA mechanism (that is, the strategy in FIG. 2), and the second strategy can refer to a strategy not using an RTS/CTS handshake in the CSMA/CA mechanism (that is, the strategy in FIG. 1).

In the present disclosure, which strategy is adopted for collision detection when transmitting the current data frame is determined through the size of the current data frame and the current threshold dynamically determined based on retransmission information of a previous data frame before the current data frame. In this way, the determined collision detection strategy can better conform to a condition of the current data frame. Correspondingly, when the data collision condition of the previous data frame is better, there is a high probability that the data collision condition of the current data frame is also better, and therefore a collision detection strategy having relatively low collision detection accuracy can be used. In addition, since the collision detection strategy having relatively low accuracy corresponds to relatively smaller number of handshake interactions, collision detection efficiency can also be improved. When the data collision condition of the previous data frame is relatively poor, there is a high probability that the data collision condition of the current data frame is also relatively poor, and therefore a collision detection strategy having relatively high collision detection accuracy can be used. In this way, in a case where the data collision condition is relatively poor, the collision detection strategy having relatively high collision detection accuracy can be adopted, thereby improving collision detection efficiency.

At S303, the current data frame is transmitted based on the data transmission strategy.

In the present disclosure, when transmitting the current data frame, collision detection can be performed using a collision detection strategy corresponding to the current data frame, and then the current data frame is transmitted.

In the present disclosure, a collision detection strategy adopted during transmission of the current data frame is determined through the size of the current data frame and the current threshold dynamically determined based on retransmission information of a previous data frame before the current data frame. Since the current threshold is dynamically determined in real time through the retransmission information of the previous data frame before the current data frame, the current threshold matches the current data frame, such that the determined collision detection strategy also matches the current data frame. In this way, based on the retransmission information of the previous data frame before the current data frame, collision detection strategies corresponding to different numbers of handshake interactions can be flexibly determined, such that a collision detection strategy corresponding to the current data frame is adopted when transmitting the current data frame, thereby improving accuracy of collision detection.

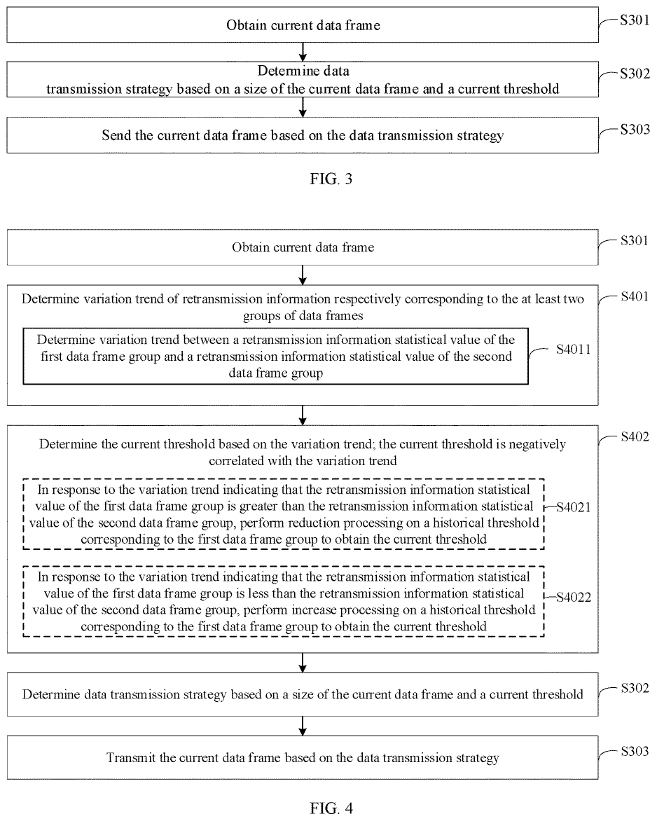

In some embodiments, the previous data frame includes at least two groups of data frames. As shown in FIG. 4, the foregoing data transmission method can further include operations S401 and S402:

At S401, a variation trend of retransmission information respectively corresponding to the at least two groups of data frames is determined.

The at least two groups of data frames can be data frame groups that are adjacent to and prior to the current data frame in transmission time, and each data frame group in the at least two groups of data frames can include at least one frame of data.

In the present disclosure, retransmission information respectively corresponding to at least one frame of data in each data frame group can first be obtained, then retransmission information corresponding to each data frame group is determined based on the retransmission information respectively corresponding to the at least one frame of data in each data frame group, and finally a variation trend of retransmission information respectively corresponding to at least two groups of data frames is determined based on the retransmission information corresponding to each data frame group.

In some embodiments, the at least two groups of data frames include a first data frame group and a second data frame group; the second data frame group is before the first data frame group; the current data frame is a next data frame after the first data frame group. The foregoing operation S401 can be implemented through operation S4011.

At S4011, a variation trend between a retransmission information statistical value of the first data frame group and a retransmission information statistical value of the second data frame group is determined.

In the present disclosure, the retransmission information statistical value of the first data frame group and the retransmission information statistical value of the second data frame group can first be determined, and then the variation trend is determined.

In some embodiments, determining the retransmission information statistical value of the first data frame group and the retransmission information statistical value of the second data frame group can include: determining the retransmission information statistical value of the first data frame group based on retransmission information respectively corresponding to at least one frame of data in the first data frame group; and determining the retransmission information statistical value of the second data frame group based on retransmission information respectively corresponding to at least one frame of data in the second data frame group.

In the present disclosure, determining the retransmission information statistical value of the first data frame group can include at least one of the following: an average value of retransmission information respectively corresponding to at least one frame of data in the first data frame group, a weighted average value of retransmission information respectively corresponding to at least one frame of data in the first data frame group, a root mean square of retransmission information respectively corresponding to at least one frame of data in the first data frame group, or an intermediate value in retransmission information respectively corresponding to at least one frame of data in the first data frame group.

In some embodiments, a manner of determining the retransmission information statistical value of the second data frame group can be the same as or different from the manner of determining the retransmission information statistical value of the first data frame group.

In some embodiments, after the retransmission information statistical value of the first data frame group and the retransmission information statistical value of the second data frame group are determined, the variation trend can be determined by calculating a difference between the retransmission information statistical value of the first data frame group and the retransmission information statistical value of the second data frame group. In a case where the difference between the retransmission information statistical value of the first data frame group and the retransmission information statistical value of the second data frame group is a positive number, it can indicate that the variation trend is an increasing trend; and in a case where the difference between the retransmission information statistical value of the first data frame group and the retransmission information statistical value of the second data frame group is a negative number, it can indicate that the variation trend is a decreasing trend.

At S402, the current threshold is determined based on the variation trend, the current threshold being negatively correlated with the variation trend.

In the present disclosure, a mapping relationship table between variation trends and threshold values can be obtained. The mapping relationship table includes mapping relationships between different variation trends and threshold values, and all mapping relationships indicate that the threshold values are negatively correlated with the variation trends. That is, when a variation trend indicates that retransmission information increases, the threshold value is reduced; and when the variation trend indicates that retransmission information decreases, the threshold value is increased.

In some embodiments, as shown in FIG. 4, operation S402 can be implemented through operations S4021 and S4022.

At S4021, in response to the variation trend indicating that the retransmission information statistical value of the first data frame group is greater than the retransmission information statistical value of the second data frame group, reduction processing is performed on a historical threshold corresponding to the first data frame group to obtain the current threshold.

At S4022, in response to the variation trend indicating that the retransmission information statistical value of the first data frame group is less than the retransmission information statistical value of the second data frame group, increase processing is performed on a historical threshold corresponding to the first data frame group to obtain the current threshold.

In the present disclosure, when the variation trend is a positive number, it indicates that the retransmission information statistical value of the first data frame group is greater than the retransmission information statistical value of the second data frame group, and reduction processing needs to be performed on the historical threshold corresponding to the first data frame group adjacent to the current data frame. When the retransmission information statistical value corresponding to the first data frame group adjacent to the current data frame increases, it indicates that data collisions may become more severe, that is, the data collision condition is relatively poor. At this time, a more accurate collision detection strategy (that is, the first strategy) needs to be adopted. After the historical threshold corresponding to the first data frame group is reduced, the first strategy can be adopted with a greater probability when transmitting the current data frame, thereby performing more accurate collision detection.

Similarly, when the variation trend is a negative number, it indicates that the retransmission information statistical value of the first data frame group is less than the retransmission information statistical value of the second data frame group, and increase processing needs to be performed on the historical threshold corresponding to the first data frame group adjacent to the current data frame. When the retransmission information statistical value corresponding to the first data frame group adjacent to the current data frame decreases, it indicates that data collisions may become more moderate, that is, the data collision condition is better. At this time, a relatively accurate collision detection strategy (that is, the second strategy) can be adopted. After the historical threshold corresponding to the first data frame group is increased, the second strategy can be adopted with a greater probability when transmitting the current data frame, thereby adopting the second strategy having relatively smaller number of handshake interactions in a case where the data collision condition of the previous data frame is better.

In the present disclosure, a variation trend between a retransmission information statistical value of a first data frame group that is a previous data frame before the current data frame and a retransmission information statistical value of a second data frame group that is before the first data frame group is determined, and then, in response to the variation trend indicating that the retransmission information statistical value of the first data frame group is greater than the retransmission information statistical value of the second data frame group, reduction processing is performed on a historical threshold corresponding to the first data frame group to obtain the current threshold; and in response to the variation trend indicating that the retransmission information statistical value of the first data frame group is less than the retransmission information statistical value of the second data frame group, increase processing is performed on the historical threshold corresponding to the first data frame group to obtain the current threshold. In this way, according to a magnitude relationship between the retransmission information statistical value of the first data frame group and retransmission information of the second data frame group, the historical threshold corresponding to the first data frame group that is a previous data frame before the current data frame can be dynamically adjusted, thereby dynamically determining the current threshold, and further performing collision detection using a collision detection strategy corresponding to the current data frame.

In some embodiments, before a first frame of data is transmitted, a preset threshold can be preset, and the preset threshold is configured to determine a data transmission strategy when the first frame of data is transmitted. This is because the first frame of data does not have a previous data frame, and therefore a current threshold corresponding to the first frame of data cannot be dynamically determined. In some embodiments, the foregoing current threshold and historical threshold are both less than the preset threshold. That is, regardless of which increase processing manner is performed on the historical threshold, the historical threshold cannot exceed the preset threshold that is preset in advance.

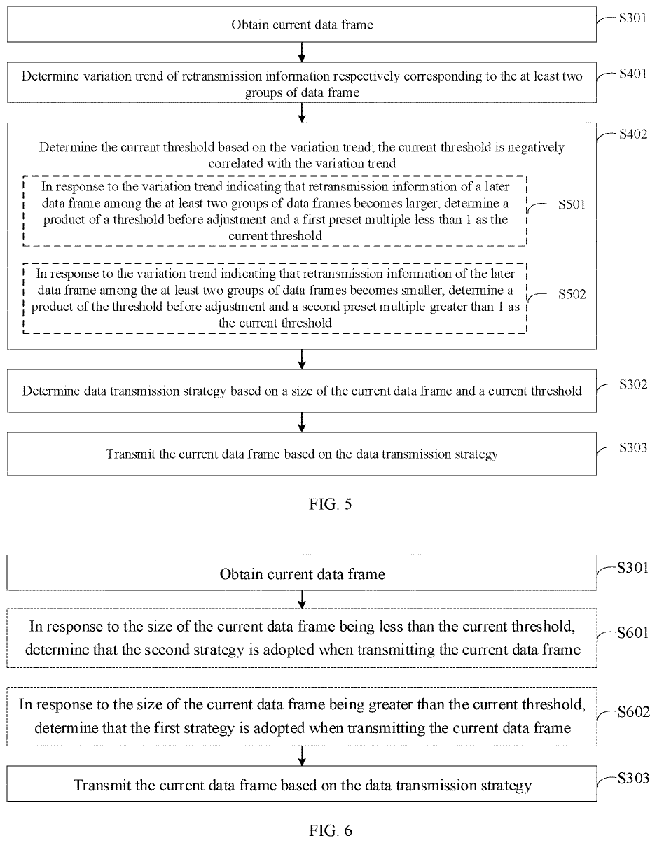

In some embodiments, as shown in FIG. 5, the foregoing operation S402 can be implemented through operations S501 and S502.

At S501, in response to the variation trend indicating that retransmission information of a later data frame among the at least two groups of data frames becomes larger, a product of a threshold before adjustment and a first preset multiple less than 1 is determined as the current threshold.

At S502, in response to the variation trend indicating that retransmission information of the later data frame among the at least two groups of data frames becomes smaller, a product of the threshold before adjustment and a second preset multiple greater than 1 is determined as the current threshold.

The threshold before adjustment is a threshold corresponding to the later data frame among the at least two groups of data frames.

In the present disclosure, in response to the variation trend indicating that retransmission information of a later data frame among the at least two groups of data frames becomes larger, it indicates that, compared with a previous data frame among the at least two groups of data frames, the later data frame is successfully transmitted only after retransmission is performed multiple times during transmission. That is, data collisions in a current channel are relatively frequent. At this time, the first strategy having more greater number of handshake interactions needs to be adopted, and therefore a product of the threshold before adjustment and the first preset multiple less than 1 can be determined as the threshold. For example, the first preset multiple can be ½. Since the first preset multiple is less than 1, this is equivalent to reducing the threshold before adjustment. Since the current threshold becomes smaller relative to the threshold before adjustment, the electronic device is more likely to use the first strategy, thereby accurately performing collision detection.

Similarly, in response to the variation trend indicating that retransmission information of the later data frame among the at least two groups of data frames becomes smaller, it indicates that, compared with a previous data frame among the at least two groups of data frames, the later data frame is successfully transmitted after relatively few retransmissions are performed during transmission. That is, data collisions in the current channel are not very frequent. At this time, the second strategy having relatively smaller number of handshake interactions may be adopted, and therefore a product of the threshold before adjustment and the second preset multiple greater than 1 can be determined as the threshold. For example, the second preset multiple can be 2. The second preset multiple is greater than 1, this is equivalent to increasing the threshold before adjustment. Since the current threshold becomes larger relative to the threshold before adjustment, the electronic device is more likely to use the second strategy.

In the present disclosure, whether retransmission information of a later data frame among at least two groups of data frames becomes larger relative to retransmission information of a previous data frame among the at least two groups of data frames can be determined through variation trends of retransmission information respectively corresponding to the at least two groups of data frames. In a case where the retransmission information of the later data frame becomes larger, a product of the threshold before adjustment and the first preset multiple less than 1 can be determined as the current threshold so as to reduce the threshold before adjustment; and in a case where the retransmission information of the later data frame becomes smaller, a product of the threshold before adjustment and the second preset multiple greater than 1 can be determined as the current threshold so as to increase the threshold before adjustment. In this way, the current threshold can be adjusted in real time based on a retransmission information variation condition of the later data frame among the at least two groups of data frames, so as to dynamically determine a collision detection strategy corresponding to the current data frame.

In some embodiments, as shown in FIG. 6, the foregoing operation S302 can be implemented through operations S601 and S602.

At S601, in response to the size of the current data frame being less than the current threshold, it is determined that the second strategy is adopted when transmitting the current data frame.

At S602, in response to the size of the current data frame being greater than the current threshold, it is determined that the first strategy is adopted when transmitting the current data frame.

In the present disclosure, after the current threshold is dynamically determined based on retransmission information of a previous data frame before the current data frame, a magnitude relationship between the size of the current data frame and the current threshold can be determined. In response to the size of the current data frame being less than the current threshold, it indicates that the size of the current data frame is relatively small. Even if a data collision occurs when transmitting the current data frame, retransmission can still be performed, and therefore the second strategy having relatively smaller number of handshake interactions can be adopted.

In response to the size of the current data frame being greater than the current threshold, it indicates that the size of the current data frame is relatively large. If a data collision occurs, a cost of retransmitting the current data frame is relatively high, which will cause efficiency loss. Therefore, the first strategy having relatively high collision detection accuracy needs to be adopted.

In the present disclosure, a magnitude relationship between a data size of the current data frame and the current threshold can be compared. In response to the size of the current data frame being less than the current threshold, collision detection is performed using the second strategy; and in response to the size of the current data frame being greater than the current threshold, collision detection is performed using the first strategy. In this way, a collision detection strategy can be determined in real time according to the magnitude relationship between the current data frame and the current threshold, thereby improving adaptability of the collision detection strategy to the current data frame.

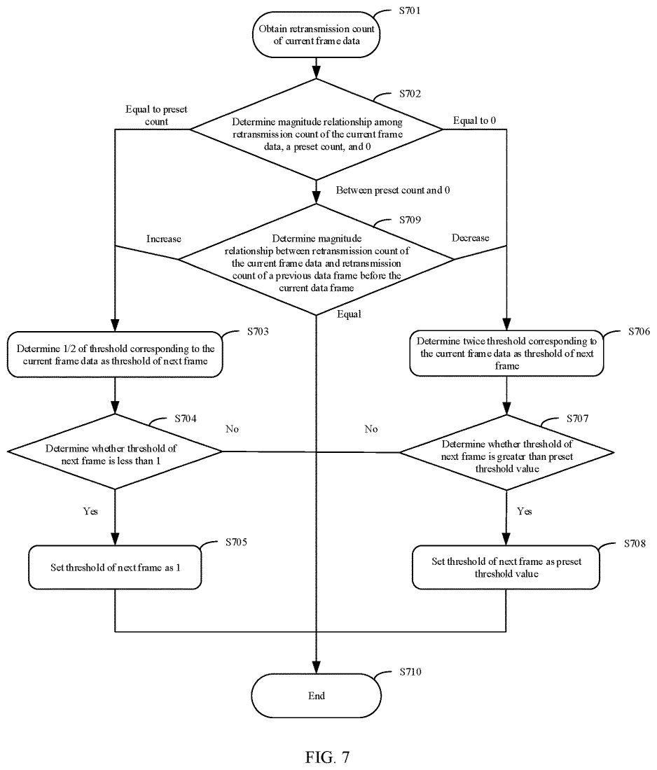

FIG. 7 is a schematic flowchart of implementation of a data transmission method in the present disclosure. As shown in FIG. 7, the method includes the following operations S701 to S710.

At S701, a retransmission count of current frame data is obtained.

At S702, a magnitude relationship among the retransmission count of the current frame data, a preset count, and 0 is determined.

In the present disclosure, in a case where the retransmission count is the preset count, operation S703 is performed; in a case where the retransmission count is 0, operation S706 is performed; and in a case where the retransmission count is between the preset count and 0, operation S709 is performed.

The preset count is used to characterize a maximum retransmission count. If the current frame data fails to be transmitted because the retransmission count exceeds the maximum retransmission count, the retransmission count of the current frame data can be set as the preset count. A retransmission count of 0 can indicate that the current data frame is successfully transmitted in one transmission and no retransmission is performed.

At S703, ½ of the threshold corresponding to the current frame data is determined as a threshold of a next frame.

At S704, whether the threshold of the next frame is less than 1 is determined.

In a case where the threshold of the next frame is less than 1, operation S705 is performed; and in a case where the threshold of the next frame is not less than 1, operation S710 is performed.

At S705, the threshold of the next frame is set as 1.

At S706, twice the threshold corresponding to the current frame data is determined as the threshold of the next frame.

At S707, whether the threshold of the next frame is greater than a preset threshold is determined.

In a case where the threshold of the next frame is greater than the preset threshold, operation S708 is performed; and in a case where the threshold of the next frame is not greater than the preset threshold, operation S710 is performed.

At S708, the threshold of the next frame is set as the preset threshold.

At S709, a magnitude relationship between the retransmission count of the current frame data and a retransmission count of a previous data frame before the current data frame is determined.

In the present disclosure, in a case where the retransmission count of the current frame data is greater than the retransmission count of the previous data frame, operation S703 is performed; in a case where the retransmission count of the current frame data is less than the retransmission count of the previous data frame, operation S706 is performed; and in a case where the retransmission count of the current frame data is equal to the retransmission count of the previous data frame, operation S710 is performed.

At S710, the process ends.

In the present disclosure, a threshold corresponding to a data frame can be gradually reduced as a retransmission count of the data frame increases. The greater the retransmission count is, the more frequent collisions are. Reduction of the threshold causes a terminal to more likely use an RTS/CTS handshake mechanism, thereby shortening a collision detection period and further improving transmission efficiency of data in a user-dense scenario.

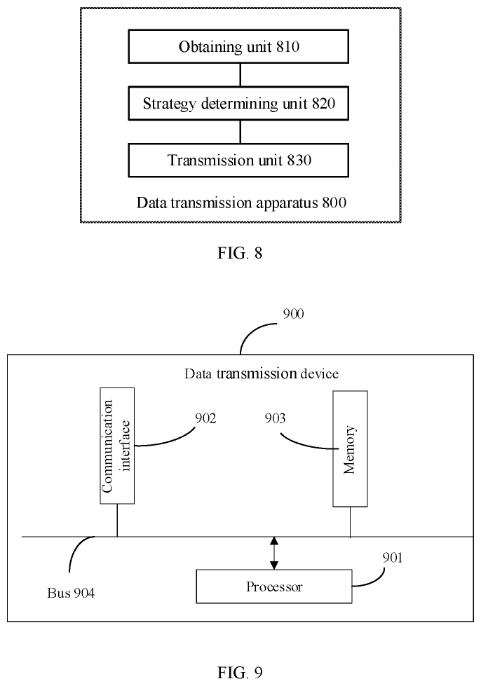

FIG. 8 is a schematic diagram of a composition structure of a data transmission apparatus in the present disclosure. As shown in FIG. 8, the data transmission apparatus 800 includes: an obtaining unit 810, a strategy determining unit 820, and a transmission unit 830.

The obtaining unit 810 is configured to obtain a current data frame;

The strategy determining unit 820 is configured to determine a data transmission strategy based on a size of the current data frame and a current threshold. The current threshold is determined based on retransmission information of a previous data frame before the current data frame. The data transmission strategy being configured to characterize a collision detection strategy adopted during transmission of the current data frame. The collision detection strategy includes a first strategy and a second strategy, and a number of handshake interactions between a receiver and a transmitter under the first strategy is greater than a number of handshake interactions between the receiver and the transmitter under the second strategy.

The transmission unit 830 is configured to transmit the current data frame based on the data transmission strategy.

In some embodiments, the previous data frame includes at least two groups of data frames; the data transmission apparatus further includes a threshold determining unit; and the threshold determining unit is configured to determine a variation trend of retransmission information respectively corresponding to the at least two groups of data frames, and determine the current threshold based on the variation trend. The current threshold is negatively correlated with the variation trend.

In some embodiments, the at least two groups of data frames include a first data frame group and a second data frame group; the second data frame group is before the first data frame group; the current data frame is a next data frame after the first data frame group; and the threshold determining unit is further configured to determine a variation trend between a retransmission information statistical value of the first data frame group and a retransmission information statistical value of the second data frame group. In response to the variation trend indicating that the retransmission information statistical value of the first data frame group is greater than the retransmission information statistical value of the second data frame group, reduction processing is performed on a historical threshold corresponding to the first data frame group to obtain the current threshold; and in response to the variation trend indicating that the retransmission information statistical value of the first data frame group is less than the retransmission information statistical value of the second data frame group, increase processing is performed on the historical threshold corresponding to the first data frame group to obtain the current threshold.

In some embodiments, the retransmission information of the previous data frame includes at least one of the following: a retransmission count of the previous data frame; a retransmission response time of the previous data frame; or a packet loss rate of the previous data frame.

In some embodiments, the threshold determining unit is further configured to: in response to the variation trend indicating that retransmission information of a later data frame among the at least two groups of data frames becomes larger, determine a product of a threshold before adjustment and a first preset multiple less than 1 as the current threshold; and in response to the variation trend indicating that retransmission information of the later data frame among the at least two groups of data frames becomes smaller, determine a product of the threshold before adjustment and a second preset multiple greater than 1 as the current threshold.

In some embodiments, the strategy determining unit 820 is further configured to: in response to the size of the current data frame being less than the current threshold, determine that the second strategy is adopted when transmitting the current data frame; and in response to the size of the current data frame being greater than the current threshold, determine that the first strategy is adopted when transmitting the current data frame.

In some embodiments, the current threshold and the historical threshold are both less than or equal to a preset threshold. The preset threshold is configured to determine a data transmission strategy when transmitting a first frame of data.

The foregoing descriptions of the apparatus embodiments are similar to the foregoing descriptions of the method embodiments, and have beneficial effects similar to those of the method embodiments. In some embodiments, functions of the apparatus or modules included in the apparatus provided in the present disclosure can be used to execute the methods described in the foregoing method embodiments. For technical details not disclosed in the apparatus embodiments of the present disclosure, reference may be made to the descriptions of the method embodiments of the present disclosure for understanding.

In the present disclosure, if the foregoing data processing methods are implemented in a form of software functional modules and sold or used as an independent product, the foregoing data processing methods can also be stored in a computer-readable storage medium. Based on such understanding, the technical solutions of the embodiments of the present disclosure, in essence, or a part making contributions to the related art, can be embodied in a form of a software product. The software product is stored in a storage medium and includes several instructions used to cause a computer device (which may be a personal computer, a server, a network device, or the like) to execute all or part of the methods in the present disclosure. The foregoing storage medium includes: various media capable of storing program codes, such as a USB flash drive, a mobile hard disk, a Read Only Memory (ROM), a magnetic disk, or an optical disk. In this way, the embodiments of the present disclosure are not limited to any specific hardware, software, or firmware, or any combination among hardware, software, and firmware.

The embodiments of the present disclosure provide a computer device, including a memory and a processor. The memory stores a computer program executable on the processor, and the processor implements part or all of the processes in the foregoing methods when executing the program.

The embodiments of the present disclosure provide a computer-readable storage medium, on which a computer program is stored, where part or all of the processes in the foregoing methods are implemented when the computer program is executed by a processor. The computer-readable storage medium may be transitory or non-transitory.

The embodiments of the present disclosure provide a computer program, including computer-readable code. In a case where the computer-readable code runs in a computer device, a processor in the computer device executes the computer-readable code to implement part or all of the processes in the foregoing methods.

The embodiments of the present disclosure provide a computer program product. The computer program product includes a non-transitory computer-readable storage medium storing a computer program, where part or all of the processes in the foregoing methods are implemented when the computer program is read and executed by a computer. The computer program product can specifically be implemented through hardware, software, or a combination thereof. In some embodiments, the computer program product is specifically embodied as a computer storage medium. In some embodiments, the computer program product is specifically embodied as a software product, such as a Software Development Kit (SDK), or the like.

The foregoing descriptions of the embodiments tend to emphasize differences among the embodiments, and same or similar portions thereof may refer to each other. The foregoing descriptions of the device, storage medium, computer program, and computer program product embodiments are similar to the foregoing descriptions of the method embodiments, and have beneficial effects similar to those of the method embodiments. For technical details not disclosed in the device, storage medium, computer program, and computer program product embodiments of the present disclosure, reference may be made to the descriptions of the method embodiments of the present disclosure for understanding.

FIG. 9 is a schematic diagram of a hardware entity of a data transmission device in embodiments of the present disclosure. As shown in FIG. 9, the hardware entity of the data transmission device 900 includes: a processor 901, a communication interface 902, and a memory 903.

The processor 901 generally controls overall operations of the computer device 900, and the overall operations can be implementation of the data transmission methods provided in the present disclosure, for example, the methods shown in FIG. 3 to FIG. 7.

The communication interface 902 can enable the computer device to communicate with other terminals or servers through a network.

The memory 903 is configured to store instructions and applications executable by the processor 901, and can further cache data to be processed or already processed by the processor 901 and various modules in the computer device 900 (for example, image data, audio data, voice communication data, and video communication data). The memory 903 can be implemented through a flash memory (FLASH) or a Random Access Memory (RAM). Data transmission among the processor 901, the communication interface 902, and the memory 903 can be performed through a bus 904.

The embodiments of the present disclosure provide a computer storage medium storing one or more programs, where the one or more programs can be executed by one or more processors to implement the operations of the method in any one of the foregoing embodiments.

The foregoing descriptions of the storage medium and device embodiments are similar to the foregoing descriptions of the method embodiments, and have beneficial effects similar to those of the method embodiments. For technical details not disclosed in the storage medium and device embodiments of the present disclosure, reference may be made to the descriptions of the method embodiments of the present disclosure for understanding.

The foregoing processor may be at least one of an Application Specific Integrated Circuit (ASIC), a Digital Signal Processor (DSP), a Digital Signal Processing Device (DSPD), a Programmable Logic Device (PLD), a Field Programmable Gate Array (FPGA), a Central Processing Unit (CPU), a controller, a microcontroller, and a microprocessor. It can be understood that electronic devices implementing the foregoing processor functions may also be other devices, and the present disclosure does not specifically limit on this.

The foregoing computer storage medium/memory may be a Read Only Memory (ROM), a Programmable Read-Only Memory (PROM), an Erasable Programmable Read-Only Memory (EPROM), an Electrically Erasable Programmable Read-Only Memory (EEPROM), a Ferromagnetic Random Access Memory (FRAM), a Flash Memory, a magnetic surface memory, an optical disk, or a Compact Disc Read-Only Memory (CD-ROM), or the like; and may also be various terminals including one of the foregoing memories or any combination thereof, such as a mobile phone, a computer, a tablet device, a personal digital assistant, or the like.

It should be understood that “one embodiment” or “an embodiment” mentioned throughout the specification means that a particular feature, structure, or characteristic related to the embodiment is included in at least one embodiment of the present disclosure. Therefore, “in one embodiment” or “in an embodiment” appearing throughout the specification does not necessarily refer to a same embodiment. In addition, these particular features, structures, or characteristics may be combined in any suitable manner in one or more embodiments. It should be understood that, in various embodiments of the present disclosure, magnitudes of sequence numbers of the foregoing operations/processes do not mean execution order thereof, and execution order of the operations/processes should be determined according to functions and inherent logic thereof, and should not constitute any limitation on implementation processes of the embodiments of the present disclosure. The foregoing sequence numbers of the embodiments of the present disclosure are merely for description, and do not represent superiority or inferiority of the embodiments.

The terms “include,” “contain,” or any other variations thereof are intended to cover non-exclusive inclusion, such that a process, method, article, or apparatus including a series of elements not only includes those elements, but also includes other elements not expressly listed, or further includes elements inherent to such process, method, article, or apparatus. Without further limitation, an element defined by the statement “including one . . . ” does not exclude existence of other identical elements in a process, method, article, or apparatus including the element.

In the several embodiments provided in the present disclosure, it should be understood that the disclosed devices and methods may be implemented in other manners. The foregoing described device embodiments are merely exemplary. For example, division of the units is merely logical functional division, and other division manners may be used in actual implementation. For example, multiple units or components may be combined, or may be integrated into another system, or some features may be omitted or not executed. In addition, coupling, direct coupling, or communication connection among the various displayed or discussed components may be indirect coupling or communication connection through some interfaces, devices, or units, and may be electrical, mechanical, or in other forms.

The foregoing units described as separate components may or may not be physically separated, and components displayed as units may or may not be physical units; the units may either be located in one place or distributed on multiple network units; and part or all of the units may be selected according to actual needs to achieve objectives of the solutions of the embodiments.

In addition, each functional unit in the present disclosure may all be integrated into one processing unit, or each unit may separately serve as one unit, or two or more units may be integrated into one unit; and the foregoing integrated units may be implemented either in a hardware form or in a form of hardware plus software functional units.

Those skilled in the art may understand that all or part of the operations of the foregoing method embodiments may be completed through hardware related to program instructions. The foregoing programs may be stored in a computer-readable storage medium, and when the programs are executed, operations including the foregoing method embodiments are executed. The foregoing storage medium includes: various media capable of storing program codes, such as a mobile storage device, a Read Only Memory (ROM), a magnetic disk, or an optical disk.

If the foregoing integrated units of the present disclosure are implemented in a form of software functional modules and sold or used as independent products, the foregoing integrated units may also be stored in a computer-readable storage medium. Based on such understanding, the technical solutions of the present disclosure, in essence, or a part making contributions to the related art, may be embodied in a form of a software product. The computer software product is stored in a storage medium and includes several instructions used to cause a computer device (which may be a personal computer, a server, a network device, or the like) to execute all or part of the methods in the present disclosure. The foregoing storage medium includes: various media capable of storing program codes, such as a mobile storage device, a ROM, a magnetic disk, or an optical disk.

The foregoing are merely embodiments of the present disclosure, but the scope of the present disclosure is not limited thereto. Any changes or substitutions that can be readily conceived by those skilled in the technical field within the technical scope disclosed in the present disclosure shall fall within the scope of the present disclosure.

What is claimed is:

1. A data transmission method comprising:
obtaining a current data frame;
determining a data transmission strategy based on a size of the current data frame and a current threshold, the current threshold being determined based on retransmission information of a previous data frame before the current data frame, the data transmission strategy being configured to characterize a collision detection strategy adopted during transmission of the current data frame, the collision detection strategy including a first strategy and a second strategy, and a number of handshake interactions between a transmitter and a receiver under the first strategy being greater than a number of handshake interactions between the transmitter and the receiver under the second strategy;
transmitting the current data frame based on the data transmission strategy.

2. The method according to claim 1,
wherein the previous data frame includes at least two groups of data frames;
the method further comprising:
determining a variation trend of retransmission information respectively corresponding to the at least two groups of data frames; and
determining the current threshold based on the variation trend, the current threshold being negatively correlated with the variation trend.

3. The method according to claim 2, wherein:
the at least two groups of data frames include a first data frame group and a second data frame group, the second data frame group is before the first data frame group, and the current data frame is a next data frame after the first data frame group.

4. The method according to claim 3, wherein determining the variation trend includes:
determining a variation trend between a retransmission information statistical value of the first data frame group and a retransmission information statistical value of the second data frame group.

5. The method according to claim 4, wherein determining the current threshold based on the variation trend includes:
in response to the variation trend indicating that the retransmission information statistical value of the first data frame group is greater than the retransmission information statistical value of the second data frame group, performing reduction processing on a historical threshold corresponding to the first data frame group to obtain the current threshold; and
in response to the variation trend indicating that the retransmission information statistical value of the first data frame group is less than the retransmission information statistical value of the second data frame group, performing increase processing on the historical threshold corresponding to the first data frame group to obtain the current threshold.

6. The method according to claim 5, wherein the current threshold and the historical threshold are both less than or equal to a preset threshold, and the preset threshold is configured to determine a data transmission strategy for transmitting a first frame of data.

7. The method according to claim 2, wherein determining the current threshold based on the variation trend includes:
in response to the variation trend indicating that retransmission information of a later data frame among the at least two groups of data frames becomes larger, determining a product of a threshold before adjustment and a first preset multiple less than 1 as the current threshold; and
in response to the variation trend indicating that the retransmission information of the later data frame among the at least two groups of data frames becomes smaller, determining a product of the threshold before adjustment and a second preset multiple greater than 1 as the current threshold.

8. The method according to claim 1, wherein the retransmission information of the previous data frame includes at least one of:
a retransmission count of the previous data frame;
a retransmission response time of the previous data frame; or
a packet loss rate of the previous data frame.

9. The method according to claim 1, wherein determining the data transmission strategy includes:
in response to the size of the current data frame being less than the current threshold, determining that the second strategy is adopted for transmitting the current data frame; and
in response to the size of the current data frame being greater than the current threshold, determining that the first strategy is adopted for transmitting the current data frame.

10. A data transmission device comprising:
a processor; and
a memory storing instructions that, when executed by the processor, cause the data transmission device to:
obtain a current data frame;
determine a data transmission strategy based on a size of the current data frame and a current threshold, the current threshold being determined based on retransmission information of a previous data frame before the current data frame, the data transmission strategy being configured to characterize a collision detection strategy adopted during transmission of the current data frame, the collision detection strategy including a first strategy and a second strategy, and a number of handshake interactions between a transmitter and a receiver under the first strategy being greater than a number of handshake interactions between the transmitter and the receiver under the second strategy; and
transmit the current data frame based on the data transmission strategy.

11. The data transmission device according to claim 10, wherein:
the previous data frame includes at least two groups of data frames; and
the instructions, when executed by the processor, further cause the data transmission device to:
determine a variation trend of retransmission information respectively corresponding to the at least two groups of data frames; and
determine the current threshold based on the variation trend, the current threshold being negatively correlated with the variation trend.

12. The data transmission device according to claim 11, wherein:
the at least two groups of data frames include a first data frame group and a second data frame group, the second data frame group is before the first data frame group, and the current data frame is a next data frame after the first data frame group.

13. The data transmission device according to claim 12, wherein the instructions, when executed by the processor, further cause the data transmission device to, when determining the variation trend:
determine a variation trend between a retransmission information statistical value of the first data frame group and a retransmission information statistical value of the second data frame group.

14. The data transmission device according to claim 13, wherein the instructions, when executed by the processor, further cause the data transmission device to, when determining the current threshold based on the variation trend:
in response to the variation trend indicating that the retransmission information statistical value of the first data frame group is greater than the retransmission information statistical value of the second data frame group, perform reduction processing on a historical threshold corresponding to the first data frame group to obtain the current threshold; and
in response to the variation trend indicating that the retransmission information statistical value of the first data frame group is less than the retransmission information statistical value of the second data frame group, perform increase processing on the historical threshold corresponding to the first data frame group to obtain the current threshold.

15. The data transmission device according to claim 14, wherein the current threshold and the historical threshold are both less than or equal to a preset threshold, and the preset threshold is configured to determine a data transmission strategy when transmitting a first frame of data.

16. The data transmission device according to claim 11, wherein the instructions, when executed by the processor, further cause the data transmission device to, when determining the current threshold based on the variation trend:
in response to the variation trend indicating that retransmission information of a later data frame among the at least two groups of data frames becomes larger, determine a product of a threshold before adjustment and a first preset multiple less than 1 as the current threshold; and
in response to the variation trend indicating that the retransmission information of the later data frame among the at least two groups of data frames becomes smaller, determine a product of the threshold before adjustment and a second preset multiple greater than 1 as the current threshold.

17. The data transmission device according to claim 10, wherein the retransmission information of the previous data frame includes at least one of:
a retransmission count of the previous data frame;
a retransmission response time of the previous data frame; or
a packet loss rate of the previous data frame.

18. The data transmission device according to claim 10, wherein the instructions, when executed by the processor, further cause the data transmission device to, when determining the data transmission strategy:
in response to the size of the current data frame being less than the current threshold, determine that the second strategy is adopted for transmitting the current data frame; and
in response to the size of the current data frame being greater than the current threshold, determine that the first strategy is adopted for transmitting the current data frame.

19. A non-transitory computer-readable storage medium storing a program that, when executed by a processor, causes a data transmission device including the processor to:
obtain a current data frame;
determine a data transmission strategy based on a size of the current data frame and a current threshold, the current threshold being determined based on retransmission information of a previous data frame before the current data frame, the data transmission strategy being configured to characterize a collision detection strategy adopted during transmission of the current data frame, the collision detection strategy including a first strategy and a second strategy, and a number of handshake interactions between a transmitter and a receiver under the first strategy being greater than a number of handshake interactions between the transmitter and the receiver under the second strategy; and
transmit the current data frame based on the data transmission strategy.

20. The storage medium according to claim 19, wherein:
the previous data frame includes at least two groups of data frames; and
the program, when executed by the processor, further causes the data transmission device including the processor to:
determine a variation trend of retransmission information respectively corresponding to the at least two groups of data frames; and
determine the current threshold based on the variation trend, the current threshold being negatively correlated with the variation trend.
